(19) United States
(12) Patent Application Publication
(10) Pub. No.: US 2015/0310493 A1
(43) Pub. Date: Oct. 29, 2015

(54) Lock-Screen-Based Advertisement Delivery Systems and Methods

(71) Applicant: Verizon Patent and Licensing Inc., Arlington, VA (US)

(72) Inventor: Siddharth Chitnis, Irving, TX (US)

(73) Assignee: Verizon Patent and Licensing Inc., Arlington, VA (US)

(21) Appl. No.: 14/262,293

(22) Filed: Apr. 25, 2014

(51) Int. Cl. G06Q 30/02

(52) U.S. Cl. CPC G06Q 30/0267; G06Q 30/0273

(57) ABSTRACT

An exemplary method includes an advertisement delivery system providing an advertisement for display together with a lock screen on a mobile device, detecting a sequence of user inputs associated with the lock screen and the advertisement, determining that the sequence of user inputs satisfies a predefined user input sequence requirement, and identifying, based on the determining that the sequence of user inputs satisfies the predefined user input sequence requirement, one or more billable impressions associated with the detected sequence of user inputs and the advertisement. Corresponding systems and methods are also described.

### BACKGROUND INFORMATION

The proliferation of mobile devices (e.g., mobile phones, tablet computers, laptop computers, etc.) in modern society has provided advertisers with numerous opportunities to direct advertisements to users of mobile devices. Unfortunately, many conventional ways of directing advertisements to users of mobile devices are less effective than desired by advertisers. For example, many conventional ways of directing advertisements to users of mobile devices produce low rates of return for advertisers (e.g., low rates of users of mobile devices actually viewing or engaging with advertisements and/or purchasing advertised products or services). Thus, there remains room for new and/or improved ways to provide advertisements to users of mobile devices.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary advertisement delivery system according to principles described herein.

FIG. 2 illustrates an exemplary advertisement delivery configuration in which the system of FIG. 1 may be implemented according to principles described herein.

FIGS. 3-5 illustrate exemplary graphical user interface views according to principles described herein.

FIG. 6 illustrates an exemplary table data structure that maps user input sequences to billable impressions and compensation amounts according to principles described herein.

FIGS. 7-8 illustrate exemplary lock-screen-based advertisement delivery methods according to principles described herein.

FIG. 9 illustrates an exemplary computing device according to principles described herein.

### DETAILED DESCRIPTION OF PREFERRED EMBODIMENTS

Exemplary lock-screen-based advertisement delivery systems and methods are disclosed. In certain examples, the systems and methods described herein may provide an advertisement for display together with a lock screen of a mobile device. Because a lock screen may be the first screen that a user of the mobile device views when accessing the mobile device, the display of the advertisement together with the lock screen may increase the probability of user interaction with the advertisement.

In certain systems and methods described herein, an advertisement delivery system may provide an advertisement for display together with a lock screen of a mobile device, detect a sequence of user inputs associated with the lock screen, and either unlock the mobile device and provide access to the advertisement or unlock the mobile device without providing access to the advertisement, based on the detected sequence of user inputs. In this regard, the advertisement delivery system may facilitate access to the advertisement based on the sequence of user inputs associated with the lock screen.

In certain examples, the advertisement delivery system may determine that the sequence of user inputs satisfies a predefined user input sequence requirement. Based on this determination, the advertisement delivery system may identify one or more billable impressions associated with the detected sequence of user inputs and the advertisement. The advertisement delivery system may perform one or more operations (e.g., data logging and/or invoicing operations) based on the identified billable impressions, such as by invoicing an advertiser for the billable impressions (e.g., by charging the advertiser specific compensation amounts mapped to the identified billable impressions).

As used herein, an “impression” may refer to any instance in which the advertisement delivery system determines that a user of a mobile device has viewed, accessed, interacted with, or otherwise been impressed by an advertisement. An impression may be defined in terms of a sequence of user inputs associated with a lock screen and/or an advertisement such that the advertisement delivery system may determine that an impression has occurred based on a particular sequence of user inputs associated with a lock screen and/or an advertisement.

An impression that has been defined as an event for which an entity such as an advertiser, a provider of a service (e.g., an advertisement delivery service), and/or an end user of the service may get credit may be referred as a “billable impression.” In some examples, a billable impression may be defined by agreement between an advertiser and a service provider. Accordingly, an entity may get credit for an occurrence of the billable impression in accordance with the terms of the agreement. In certain examples, the advertisement delivery system and/or a provider of the advertisement delivery system may charge an advertiser and/or receive compensation for an occurrence of a billable impression.

In certain examples, there may be one or more billable impressions associated with an advertisement provided for display together with a lock screen on a mobile device. Specific examples of billable impressions and how they may be associated with a detected sequence of user inputs associated with an advertisement and/or a lock screen are provided herein.

Systems and methods described herein may facilitate a convenient, intuitive, relevant, and/or unobtrusive way for users to discover advertisements that are provided for display together with a lock screen of a mobile device. Systems and methods described herein may additionally or alternatively facilitate efficient ways for advertisers to direct advertisements to users in a manner that may increase the probability of user engagement with the advertisements and/or the rates of return for advertisement campaigns. Additionally or alternatively, systems and methods described herein may facilitate convenient ways for advertisers to collect information that may be used by the advertisers to optimize advertisement campaigns. These and/or additional or alternative benefits and/or advantages that may be provided by systems and methods described herein will be made apparent by the following description. Exemplary lock-screen-based advertisement delivery systems and methods will now be described in reference to the accompanying drawings.

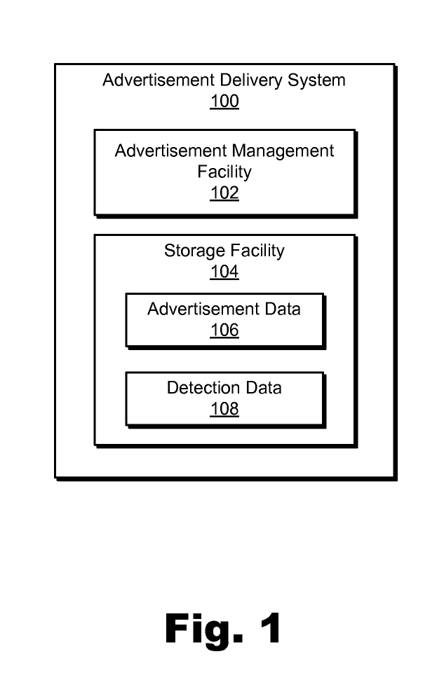

FIG. 1 illustrates an exemplary advertisement delivery system 100 (“system 100”). System 100 may be configured to facilitate discovery, access, and/or engagement with advertisements by one or more users. For example, system 100 may be configured to provide advertisements to one or more end-users of a service (e.g., an advertisement delivery service, a mobile communications service, etc.). System 100 may be associated with (e.g., operated by) a provider of the service (“service provider”). Through the service, an end user of the service may discover, access, and/or engage with advertisements distributed by system 100.

As shown in FIG. 1, system 100 may include, without limitation, an advertisement management facility 102 (“management facility 102”) and a storage facility 104 selectively and communicatively coupled to one another. Facilities 102-104 may be communicatively coupled one to another by any suitable communication technologies.

It will be recognized that although facilities 102-104 are shown to be separate facilities in FIG. 1, any of those facilities may be combined into a single facility or split into additional facilities as may serve a particular implementation. Additionally or alternatively, one or more of the facilities 102-104 may be omitted from and external to system 100 in other implementations. Facilities 102-104 will now be described in more detail.

Storage facility 104 may be configured to store advertisement data 106 representative of advertisements that may be delivered by management facility 102 and any information associated with the advertisements (e.g., information about advertisement campaigns, advertisers, etc.). Storage facility 104 may also store detection data 108 representative of data that may be detected by management facility 102 in relation to delivery of advertisements. For example, detection data 108 may represent user inputs associated with advertisements.

Management facility 102 may be configured to perform one or more operations associated with delivery of advertisements to a mobile device (e.g., a mobile phone, a tablet computer, a laptop computer, etc.). Examples of such operations are described herein.

To facilitate delivery of advertisements to a mobile device, management facility 102 may maintain advertisement data 106 representative of one or more advertisements and/or any other information that may be associated with the one or more advertisements. For example, management facility 102 may maintain a catalogue of advertisements. The advertisements may be in any form suitable for delivery to a mobile device. For example, the advertisements may include, but are not limited to, text-based advertisements (i.e., advertisements that primarily include text), image-based advertisements (i.e., advertisements that include one or more images), video advertisements (i.e., advertisements that include one or more video clips), coupons, discounts, promotional opportunities, selectable links, interactive advertisements, and/or any other type of advertising content as may serve a particular implementation.

Management facility 102 may receive data representative of advertisements in any suitable manner and from any suitable source. In certain examples, at least some of the advertisements may originate from a provider (e.g., an advertisement delivery service provider, a mobile communications service provider, etc.) of a service provided by system 100 and/or from an operator of system 100. Such advertisements may be associated with any of the content and/or features that may be provided by way of the service. In certain examples, at least some of the advertisements may originate from one or more advertisers, which may be entities separate from the provider of the service and/or system 100.

Management facility 102 may be configured to select and provide any of the advertisements represented by advertisement data 106 to a mobile device for display together with a lock screen of the mobile device. This may be performed in any suitable way. For example, management facility 102 may use any information associated with an advertisement campaign, information about the mobile device or a user of the mobile device, and/or any other suitable information to select an advertisement to provide to the mobile device. Management facility 102 may provide the selected advertisement to the mobile device in any suitable way, such as by providing (e.g., transmitting) data representative of the advertisement to the mobile device and/or to a user interface module of the mobile device such that the mobile device displays the advertisement together with a lock screen of the mobile device.

The advertisement may be displayed together with a lock screen of the mobile device in any suitable way. For example, the advertisement and the lock screen may be concurrently displayed on a display screen of the mobile device, such as by concurrently displaying the advertisement and the lock screen on different portions of the display screen, overlaying the advertisement on the lock screen, overlaying the lock screen on the advertisement, displaying the lock screen with the advertisement integrated therein, positioning the advertisement behind a transparent portion of the lock screen, and/or by concurrently displaying the advertisement and the lock screen on the display screen in any other suitable way.

Management facility 102 may detect user input associated with the advertisement and/or the lock screen. The user input may include any sequence of one or more user inputs provided by a user in relation to the advertisement and/or the lock screen (e.g., one or more user inputs provided by the user while the lock screen and/or advertisement are displayed). For example, while the advertisement is displayed together with the lock screen, the user may provide input configured to unlock the mobile phone and access the advertisement.

Management facility 102 may detect user input associated with the advertisement and/or the lock screen in any suitable way. For example, management facility 102 may receive data representative of the user input from the mobile device and/or a user interface module of the mobile device.

Management facility 102 may determine whether a detected sequence of user inputs associated with the advertisement and/or the lock screen satisfies a predefined user input sequence requirement. As used herein, a “predefined user input sequence requirement” may refer to any sequence of user inputs that has been defined to be associated with (e.g., to represent or to be indicative of) one or more billable impressions. The predefined user input sequence requirement may be defined, for example, by an advertiser and/or an operator of system 100 in any suitable manner. For example, before management facility 102 provides advertisement for display together with a lock screen of a mobile device, an advertiser and/or the operator of system 100 may define (e.g., in advertisement data 106) a user input sequence requirement to include a specific sequence of one or more user inputs (e.g., a first user input followed by a second user input) and to be associated with one or more billable impressions. Management facility 102 may then monitor, in any suitable manner, user input associated with a lock screen and/or an advertisement and determine whether the user input satisfies the predefined user input sequence requirement. For example, if a user enters the first user input followed by the second user input as specified by the predefined user input sequence requirement, management facility 102 may determine that the predefined user input sequence requirement is satisfied.

In certain examples, a plurality of predefined user input sequence requirements may be defined by an advertiser and/or an operator of system 100 for a given advertisement, lock screen, and/or advertisement campaign. In some such examples, user inputs associated with a first predefined user input sequence requirement may overlap with user inputs associated with a second predefined user input sequence requirement. For example, the first predefined user input sequence requirement may require the user to enter a first user input and a second user input, and the second predefined user input sequence requirement may require the user to enter the first user input, the second user input, and a third user input. That is, the first and the second user inputs overlap between the first and the second predefined user input sequence requirements.

In this regard, when the user inputs the first, the second, and the third user inputs, management facility 102 may determine that both the first and the second predefined user input sequence requirements are satisfied. Specific examples of predefined user input sequence requirements are provided herein.

Management facility 102 may facilitate definition by an advertiser and/or an operator of system 100 of one or more specific billable impressions for an advertisement and/or advertisement campaign. For example, the advertiser and/or the operator of system 100 may specify one or more specific billable impressions as being associated with a defined user input sequence requirement. Management facility 102 may maintain data (e.g., advertisement data 106) representative of the defined billable impressions and associated user input sequence requirements and may utilize such data in providing a service.

Management facility 102 may identify one or more billable impressions associated a detected sequence of user inputs provided by a user in relation to an advertisement provided for display together with a lock screen of a mobile device. Management facility 102 may identify the one or more billable impressions in any suitable way. For example, to facilitate such an identification, one or more billable impressions may be mapped, by definition, to one or more predefined user input sequence requirements, as described above. Management facility 102 may maintain and use data representative of the mappings (e.g., a data structure representing the mappings) to identify which billable impressions are associated with a detected sequence of user inputs that is determined to satisfy a predefined user input sequence requirement. To illustrate, when management facility 102 determines that a predefined user input sequence requirement has been satisfied by a detected sequence of user inputs, management facility 102 may access a data structure to identify which billable impression or billable impressions is/are mapped to the satisfied predefined user input sequence requirement. A specific example of a data structure that may be used by management facility 102 to identify billable impressions is described herein.

In certain examples, management facility 102 may identify one or more billable impressions as a result of a single predefined user input sequence requirement being satisfied. For example, the information included in the data structure may indicate that a first billable impression is associated with a first predefined user input sequence requirement and a second billable impression is associated with a second predefined user input sequence requirement. As mentioned, the user inputs associated with the second predefined user input sequence requirement may overlap with the user inputs associated with the first predefined user input sequence requirement (i.e., a first user input and a second user input may be the same between the first and the second predefined user input sequence requirements). As a result of this overlap, when management facility 102 determines that the second predefined user input sequence requirement has been satisfied, management facility 102 may identify both the first and the second billable impressions as having occurred. In this or a similar manner, the one or more billable impressions may include tiered billable impressions where one or more billable impressions may result from the satisfaction of a particular predefined user input sequence requirement.

Management facility 102 may perform one or more operations associated with the identified billable impressions. The one or more operations may be performed by management facility 102 in any suitable manner and, in certain examples, may include one or more operations associated with providing a service (e.g., an advertisement delivery service) to a user and/or an advertiser. In certain examples, the one or more operations may be associated with a provider of a service and/or an operator of system 100 invoicing an advertiser based on the identified billable impressions. Examples of such invoicing-related operations based on identified billable impressions are provided herein.

Additionally or alternatively, the one or more operations may be associated with detecting and/or recording statistical data associated with the identified billable impressions. Such statistical data may include any data associated with how a user interacts and/or does not interact with advertisements provided by way of the service. Management facility 102 may use such statistical data to analyze and/or optimize advertisements and/or advertisement campaigns provided by way of the service. Examples of such statistical-data-related operations are provided herein.

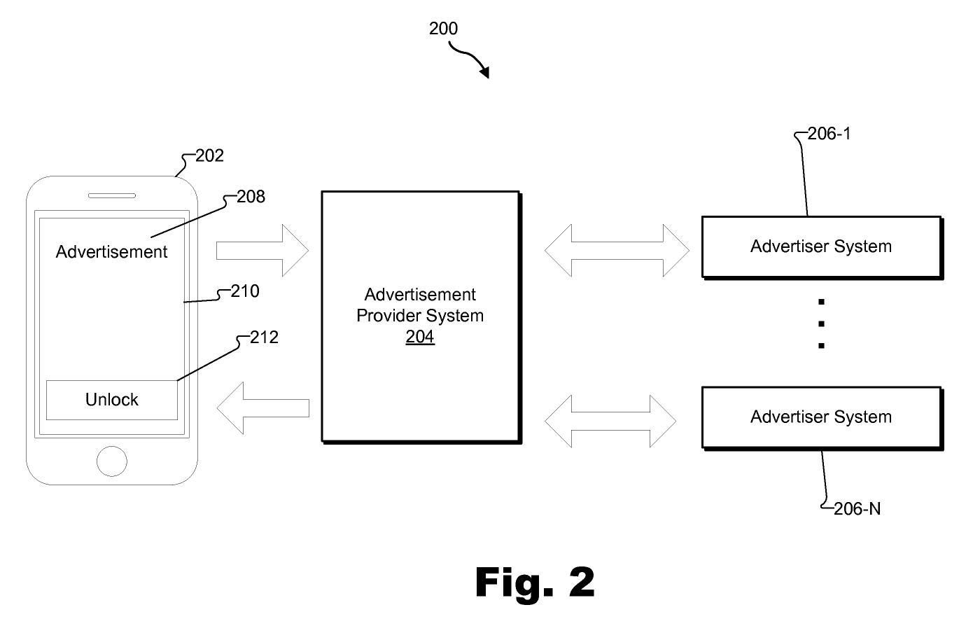

FIG. 2 shows an exemplary advertisement delivery configuration 200. As shown, configuration 200 may include a mobile device 202, which may be associated with a user such as an end user of a service provided by system 100. Mobile device 202 may be in communication with an advertisement provider system 204 (“provider system 204”), which may include one or more computing devices (e.g., server devices remotely located from mobile device 202 and/or operated by a provider of the service). In addition to being in communication with mobile device 202, provider system 204 may also be in communication with one or more advertiser systems 206 (e.g., advertiser systems 206-1 through 206-N), which may include one or more computing devices (e.g., server and/or client devices remotely located from provider system 204) associated with (e.g., operated by) advertisers. Communications between mobile device 202, provider system 204, and advertiser systems 206 are represented by arrows in FIG. 2.

Mobile device 202, provider system 204, and advertiser systems 206 may communicate using any communication platforms and technologies suitable for transporting data (e.g., advertisement data 106) and/or communication signals, including known communication technologies, devices, media, and protocols supportive of remote communications, examples of which include, but are not limited to, data transmission media, communications devices, Transmission Control Protocol (“TCP”), Internet Protocol (“IP”), Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Long Term Evolution (“LTE”) technologies, Multimedia Message Service (“MMS”), radio frequency (“RF”) signaling technologies, wireless communication technologies, Internet communication technologies, media streaming technologies, media download technologies, and other suitable communications technologies.

In certain embodiments, mobile device 202, provider system 204, and advertiser systems 206 may communicate via one or more networks, such as one or more wireless networks (Wi-Fi networks), wireless communication networks, mobile telephone networks (e.g., cellular telephone networks), closed media networks, open media networks, closed communication networks, open communication networks, wide area networks (e.g., the Internet), local area networks, and any other networks capable of carrying data (e.g., streaming and/or downloading media programs) and/or communications signals between mobile device 202, provider system 204, and advertiser systems 206. Communications between mobile device 202, provider system 204, and advertiser systems 206 may be transported using any one of the above-listed networks, or any combination or sub-combination of the above-listed networks. Alternatively, mobile device 202, provider system 204, and advertiser systems 206 may communicate in another way such as by direct connections between mobile device 202, provider system 204, and advertiser systems 206.

Components of system 100 may be implemented by one or more of the elements of configuration 200 shown in FIG. 2. For example, in certain implementations, components of system 100 may be implemented entirely by mobile device 202, entirely by provider system 204, or distributed across mobile device 202 and provider system 204. In such implementations, a user of mobile device 202 may use the mobile device 202 to access and engage with advertisements distributed by provider system 204 as part of a service provided by system 100 and/or provider system 204.

Provider system 204 may receive and maintain data representative of advertisements for use in selecting and delivering advertisements to mobile device 202. The data may be received from any suitable source. For example, the data may be input by an operator of provider system 204 and/or received from advertiser systems 206 (e.g., by way of a portal such as a web portal). Provider system 204 may maintain the data in any suitable way, such as by maintaining data representative of a catalogue of advertisements from which to select advertisements to distribute to mobile device 202.

In certain examples, provider system 204 may receive data representative of advertisement campaigns. Such data may specify one or more parameters configured for use by provider system 204 to execute the advertisement campaigns, which execution may include provider system 204 selecting and distributing advertisements to mobile device 202. Examples of advertisement campaign parameters may include defined criteria for use by provider system 204 to determine how to select and distribute advertisements, user input sequence requirements associated with advertisements, billable impressions, and/or compensation amounts of an advertisement campaign.

In certain examples, an advertiser may set up an advertisement campaign to be executed by provider system 204. In such examples, the advertiser may enter into an agreement with a service provider. The agreement may specify the terms of the service provided by the service provider to the advertiser and/or how the advertiser will compensate the service provider for the service. For example, the advertiser may agree to compensate the service provider based on specific user input sequence requirements and/or billable impressions associated with delivery of one or more advertisements by way of the service.

In certain examples, an advertiser may use an advertiser system 206 to define an advertisement campaign to be executed by provider system 204. For example, using the advertiser system 206, the advertiser may access and use a portal provided by provider system 204 to upload data representative of the advertisement campaign to provider system 204. In certain examples, the provided data may represent a proposed advertisement campaign, and the service provider may review the proposed advertisement campaign and either agree to execute the advertisement campaign as proposed or may negotiate modifications to the proposed advertisement campaign. Alternatively, the advertisement campaign defined by the advertiser may align with terms set forth by the service provider or previously agreed upon by the advertiser and the service provider.

In other examples, representatives of an advertiser and the service provider may work out terms of an advertisement campaign in any suitable manner, and an operator of provider system 204 may input data representative of the advertisement campaign into provider system 204 such that provider system 204 is configured to execute the advertisement campaign.

As mentioned, parameters of an advertisement campaign may specify user input sequence requirements associated with advertisements. To this end, in certain examples, when defining an advertisement campaign, an advertiser and/or service provider may define a particular user input sequence requirement that is to be satisfied by user input associated with an advertisement. In certain examples, there may be a plurality of predefined user input sequence requirements for any given advertisement and/or advertisement campaign.

As further mentioned, parameters of an advertisement campaign may specify one or more billable impressions. To this end, in certain examples, when defining an advertisement campaign, an advertiser and/or service provider may define one or more billable impressions associated with an advertisement and/or user input sequence requirements.

As further mentioned, parameters of an advertisement campaign may specify one or more compensation amounts to be paid by an advertiser for the service. For example, the parameters may specify one or more specific compensation amounts to be paid by the advertiser for the occurrence(s) of one or more billable impressions. Such compensation amounts may be determined, for example, by the advertiser and/or the service provider. The compensation amounts for the billable impressions may be the same or may vary from one advertisement campaign to another advertisement campaign. In addition, the compensation amounts for the billable impressions in a single advertisement campaign may vary depending on an agreement between the advertiser and the service provider. For example, an advertiser may be willing to pay more for a billable impression that results in a purchase of a product or service than the advertiser may be willing to pay for a billable impression that indicates only that a user accessed (e.g., viewed) an advertisement.

Provider system 204 may maintain data representative of parameters of an advertisement campaign in any suitable manner. For, example, provider system 204 may create and/or store a data structure that includes data representative of parameters of an advertisement campaign. An example of a data structure representing parameters of an advertisement campaign is provided herein.

Provider system 204 may select an advertisement to provide to mobile device 202 in any suitable manner. For example, provider system 204 may access and use data maintained by provider system 204 (e.g., advertisement campaign data) to select which advertisement to provide to mobile device 202. Provider system 204 may make such a selection in a targeted manner or a non-targeted manner. When provider system 204 selects an advertisement in a non-targeted manner, the advertisement may be distributed generally to one or more mobile devices without referring to specific information associated with the one or more mobile devices and/or users of the mobile devices. On the other hand, when provider system 204 selects an advertisement in a targeted manner, the advertisement may be directed to a specific mobile device or group of mobile devices based on information associated with the mobile devices and/or users of the mobile devices.

Provider system 204 may utilize any suitable information to select a targeted advertisement to provide to mobile device 202. For example, provider system 204 may access historical, demographic, and/or behavioral information from one or more sources and/or profiles to select advertisements to deliver to mobile device 202. In certain examples, a targeted advertisement may be directed by provider system 204 at a specific target individual and/or group, based on, for example, household targeting information, advertisement campaign information, geographical location information (e.g., based on zip code), demographic information (e.g., age, income, gender, etc.), psychographic information (e.g., information associated with user personality, values, attitudes, interests, lifestyle, etc.), and geographic location information such as the location of mobile device 202 (e.g., via a Global Positioning System (“GPS”) in mobile device 202, triangulation techniques, etc.). Provider system 204 may use any combination of such information to select a targeted advertisement to deliver to mobile device 202.

In certain examples, provider system 204 may select an advertisement to deliver to mobile device 202 based on a geographic location of mobile device 202. Provider system 204 may determine the geographic location of mobile device 202 in any suitable manner. For example, mobile device 202 may inform provider system 204 of the geographic location. Alternatively, provider system 204 may detect the geographic location of mobile device 202 in any suitable way and using any suitable technologies, including, without limitation, GPS technologies, terrestrial signaling triangulation technologies, etc. In certain implementations, provider system 204 may detect the geographic location of mobile device 202 relative to (e.g., within) a particular geographic space (e.g., within a site premises such as a shopping mall, office building, or other structure). Based on the geographic location, provider system 204 may select an advertisement to deliver to mobile device 202.

To illustrate, provider system 204 may detect, in any suitable manner, that mobile device 202 is within a predefined vicinity of a shopping mall. Provider system 204 may then select an advertisement to deliver to mobile device 202 while the user is within the predefined vicinity associated with the shopping mall.

In certain examples, provider system 204 may select an advertisement to send to mobile device 202 based on a user of mobile device 202 being registered with the service. Registration with the service may facilitate user control over how advertisements may be selected and provided by provider system 204 to the user through the service. This may increase the probability of the user being interested in and engaging with the advertisements.

Provider system 204 may facilitate registration of a user with the service. For example, provider system 204 may provide a portal (e.g., a website) for access and use by the user to register with the service. The user may use mobile device 202 or any other suitable user device to access the portal and register the mobile device 202 with the service. Provider system 204 may receive registration data from mobile device 202 and/or from any other computing device used by the user to register with the service.

The registration data may include any data that may be utilized by provider system 204 to provide advertisements to the user. For example, the registration data may include demographic information, psychographic information (e.g., information associated with the personality, values, attitudes, interests, and lifestyles of the user), behavioral information, historical information, and/or any other suitable information that may be associated with the user. In certain examples, the registration data may include information indicating that the user agreed to receive advertisements for display together with a lock screen on mobile device 202 as part of the service. That is, the user may opt-in to receiving such advertisements by registering with the service.

Provider system 204 may provide one or more tools for use by the user to customize the delivery of advertisements to mobile device 202. In certain examples, for instance, a user may not want to receive advertisements by way of the service during specific time periods. Provider system 204 may provide a tool for use by the user to define time periods during which the user does not want to receive advertisements by way of the service. For example, provider system 204 may prompt the user to specify, during registration, whether there are any times and/or time periods in which the user does not want to receive advertisements. For example, the user may not want to receive advertisements while the user is at work (e.g., from 9:00 AM to 5:00 PM on weekdays). Accordingly, when prompted by provider system 204, the user may utilize a tool provided by provider system 204 to indicate, in any suitable manner, that the user does not want to receive advertisements during working hours.

As another example, the user may want to receive advertisements by way of the service during specific time periods. Provider system 204 may provide a tool for use by the user to define time periods during which the user wants to receive advertisements by way of the service. For example, provider system 204 may prompt the user to specify, during registration, whether there are any times and/or time periods in which the user wants to receive advertisements. For example, the user may want to receive advertisements when the user first wakes up in the morning (e.g., at 6:00 AM). Accordingly, when prompted by provider system 204, the user may indicate, in any suitable manner, during registration or afterwards that the user would like to receive advertisements when the user first accesses mobile device 202 in the morning.

As another example, the user may want to receive an advertisement when the user is within a predefined vicinity of a geographic location (e.g., a geographic location associated with a shopping facility, a business facility, a government facility, a park, a recreational area, etc.). Provider system 204 may provide a tool for use by the user to define the vicinity and/or the geographic location. For example, provider system 204 may prompt the user to specify, during registration, a geographic location and/or an area associated with the geographic location within which the user would like to receive advertisements. For example, the user may want to receive advertisements when the user is within a one mile radius of a specific grocery store. Accordingly, when prompted by provider system 204, the user may indicate, in any suitable manner, during registration or afterwards that the user would like to receive advertisements when the user enters within the one mile radius of the grocery store.

As another example, during or after registration, provider system 204 may request authorization to track the user's purchase and engagement patterns. The user may accept or decline such authorization during or after registration in any suitable manner. If the user grants authorization, provider system 204 may track and use user activities to customize the delivery of advertisements to mobile device 202.

The registration process described above is for illustrative purposes only. It is understood that in some implementations, provider system 204 may provide an advertisement for display together with a lock screen on mobile device 202 without the user being registered with the service.

In certain examples, provider system 204 may, when selecting an advertisement to deliver to mobile device 202, determine that a user of mobile device 202 may be interested in one or more of advertisements that may be provided by way of the service. If the user is registered with the service, such a determination may be made based on the registration data received by provider system 204. Alternatively, such a determination may be made based on any other suitable information that provider system 204 may obtain from and/or attribute to the user.

When provider system 204 determines that a particular user may be interested in one or more advertisements, provider system 204 may facilitate a real time bidding process in which advertisers (e.g., by way of advertiser systems 206) may bid to have their respective advertisements provided to that particular user. Provider system 204 may facilitate the real time bidding process in any suitable manner. For example, the advertisers may access a portal (e.g., a website) provided by provider system 204 and bid monetary amounts for the right to provide an advertisement to a particular user or a group of users by way of the service. To illustrate, in the example shown in FIG. 2, provider system 204 may determine that the user associated with mobile device 202 may be interested in advertisements provided by advertiser system 206-1 and advertiser system 206-N (e.g., advertisements from two different advertisement campaigns). Provider system 204 may inform advertiser systems 206-1 and 206-N of such a determination, at which point advertiser system 206-1 and 206-N may enter into the real time bidding process in which advertiser systems 206 place bids to provider system 204 to determine which advertisement will be presented to the user. As a result of the real time bidding process, advertiser system 206-1 may bid higher (e.g., a higher monetary amount) than advertiser system 206-N. Based on the higher bid, provider system 204 may select the advertisement from advertiser system 206-1 to deliver to mobile device 202.

Alternatively, the real time bidding process may be based on information previously provided by advertisers. For example, advertisement campaign information previously provided by advertisers may include information specifying monetary amounts that the advertisers are willing to pay for delivery of advertisements to users. Thus, when provider system 204 is selecting an advertisement from multiple advertisements, provider system 204 may select the advertisement having the relatively highest compensation amount for delivery of the advertisement.

After selecting an advertisement based on any suitable criteria (e.g., advertisement campaign parameters, user information, mobile device location data, etc.), provider system 204 may deliver (e.g., transmit) the advertisement to mobile device 202 in any suitable manner. For example, provider system 204 may deliver the advertisement in advance to mobile device 202 to be stored in a memory of mobile device 202. In such an example, mobile device 202 may retrieve the advertisement from the memory and provide the advertisement for display together with a lock screen on a display screen of mobile device 202 in response to certain criteria being satisfied (e.g., in response to an event detected by mobile device 202, based on an instruction from provider system 204, etc.). Alternatively, provider system 204 may deliver the advertisement to mobile device 202 in real time when mobile device 202 is in a lock state and/or when a lock screen is provided for display on mobile device 202. For example, provider system 204 may detect that a lock screen is currently provided for display on mobile device 202 and may provide an advertisement to mobile device 202 on-the-fly based on the detection.

Mobile device 202 may display an advertisement together with a lock screen associated with the mobile device 202 in any suitable manner. In the example illustrated in FIG. 2, an advertisement selected by provider system 204 is provided and displayed as advertisement 208 together with a lock screen 210 of mobile device 202. Advertisement 208 may be displayed together with lock screen 210 in any suitable manner, including in any of the ways disclosed herein. In certain examples, advertisement 208 may be a full screen advertisement (e.g., may occupy substantially an entire display screen of mobile device 202). The configuration of advertisement 208 illustrated in FIG. 2 is provided for illustrative purposes only. Advertisement 208 may be provided for display together with lock screen 210 in other ways in other implementations.

The lock screen with which an advertisement is displayed may be any screen view that is displayed on a display screen of a mobile device during a lock state of the mobile device and/or that provides a mechanism for use by a user to unlock the mobile device from the lock state. The lock screen may be a native lock screen or a non-native lock screen. As used herein, a “native lock screen” may refer to a standard lock screen (i.e., a default lock screen) of a mobile device, such as a lock screen that is provided by an operating system and/or firmware of the mobile device. A “non-native lock screen” may refer to any other type of lock screen that may be provided in addition to, or in replacement of, a native lock screen, such as a lock screen that is provided by an after-market application installed and running on the mobile device. Specific examples of an advertisement provided for display together with a native lock screen and/or a non-native lock screen are provided herein.

When advertisement 208 is displayed together with lock screen 210 on mobile device 202, a user of mobile device 202 may choose to either ignore advertisement 208 or engage with advertisement 208 by entering a sequence of user inputs associated with advertisement 208 and lock screen 210. For example, the user of mobile device 202 may enter any suitable user input to unlock mobile device 202. Such user input may include user input associated with a graphical object 212 that is identified as “Unlock” in FIG. 2 and that represents an unlock mechanism for use by a user to unlock mobile device 202 from a lock state.

In certain examples, a sequence of user inputs associated with an advertisement and a lock screen may include one or more user inputs that interact with one or more unlock mechanisms to unlock mobile device 202 from a lock state. The sequence of user inputs may include additional user inputs that are provided by a user immediately before or after the user inputs that interact with one or more unlock mechanisms to unlock mobile device 202 from a lock state. Together, such a set of user inputs may form a particular sequence of user inputs associated with an advertisement and a lock screen.

In certain examples, a sequence of user inputs may include user inputs for unlocking a plurality of lock screens. For example, lock screen 210 may correspond to a non-native lock screen of mobile device 202. In such an example, provider system 204 may detect a user input associated with graphical object 212 and, in response, provide a native lock screen for display on a display screen associated with mobile device 202. The user may then provide one or more additional user inputs to interact with the native lock screen to unlock mobile device 202 and access advertisement 208.

Specific examples of an advertisement provided for display together with one or more lock screens of a mobile device, sequences of user inputs associated with the advertisement and the one or more lock screens, and operations that may be performed by management facility 102 based on the sequences of user inputs will now be described.

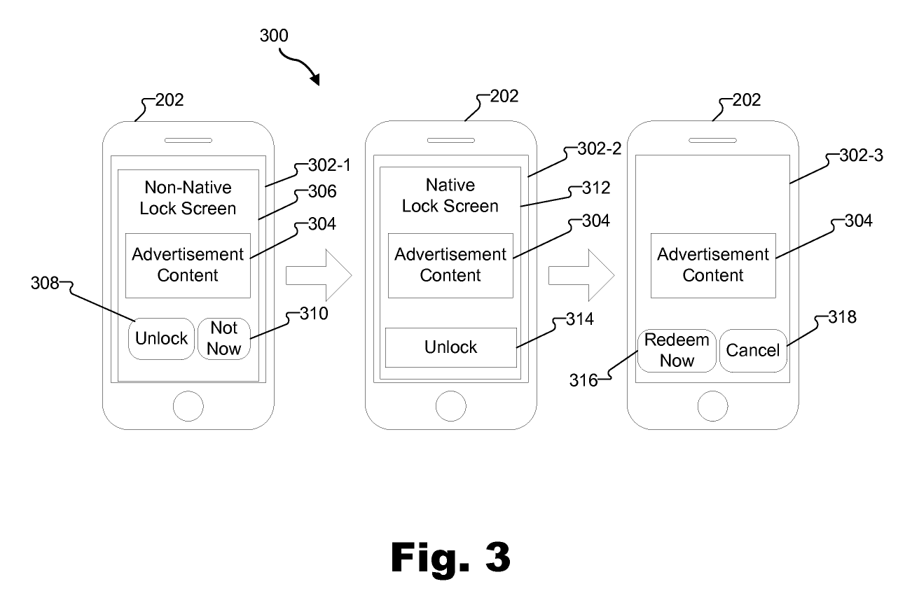

FIG. 3 shows a progression 300 of exemplary graphical user interface views (e.g., views 302-1 through 302-3) that may be provided by management facility 102 for display on mobile device 202. When a user accesses mobile device 202 in a lock state, the user may be presented with view 302-1. As shown in FIG. 3, view 302-1 may include an advertisement 304 displayed together with a non-native lock screen 306.

In certain examples, management facility 102 may tailor non-native lock screen 306 specifically to advertisement 304. For example, non-native lock screen 306 may include information and/or graphical objects that are associated with the specific advertisement 304. In other examples, the information and/or graphical objects in non-native lock screen 306 may not be tailored specifically to the displayed advertisement 304.

In certain examples, non-native lock screen 306 may include a first graphical object that, when selected by a user, facilitates further access to advertisement 304, and a second graphical object that, when selected by the user, dismisses the advertisement 304. Management facility 102 may provide the first and second graphical objects for display in non-native lock screen 306 in any suitable manner. To illustrate, in the example shown in FIG. 3, a graphical object 308 identified as “Unlock” and a graphical object 310 identified as “Not Now” are included in non-native lock screen 306. Graphical object 308 may facilitate a user unlocking mobile device 202 through any suitable user input associated with graphical object 308. On the other hand, graphical object 310 may facilitate the user dismissing advertisement 304 through any suitable user input associated with graphical object 310. The example illustrated in FIG. 3 is illustrative only. Additional or alternative input mechanisms may be provided together with advertisement 304 to facilitate the user further accessing or dismissing advertisement 304.

If management facility 102 detects that the user dismisses advertisement 304 through any suitable user input (e.g., a selection of graphical object 310), the mobile device 202 may be directed to revert to a hibernated state (e.g., a state in which the display screen of the mobile device goes dark) or to switch to a display of a view of a native lock screen that does not include advertisement 304. In this or a similar manner, a user may conveniently dismiss advertisement 304 displayed in view 302-1.

On the other hand, if management facility 102 detects that the user selects further access to advertisement 304 (e.g., by a user selection of graphical object 308), management facility 102 may cause mobile device 202 to provide view 302-2 for display. As illustrated in FIG. 3, view 302-2 may include advertisement 304 provided together with a native lock screen 312 of mobile device 202. As discussed, native lock screen 312 may correspond to a standard lock screen of mobile device 202, and advertisement 304 may be provided for display together with native lock screen 312. To unlock mobile device 202, the user may enter the standard user input that would be entered to unlock mobile device 202 when advertisement 304 is not displayed together with native lock screen 312. For example, the user of mobile device 202 may make a sliding motion from left to right on graphical object 314 to unlock mobile device 202. In some examples, the user may also have to enter an access code or may have to satisfy some other security access feature to unlock mobile device 202.

If management facility 102 does not detect a user input associated with view 302-2, mobile device 202 may revert to a hibernated state. Alternatively, if management facility 102 detects user input associated with native lock screen 312 that unlocks mobile device 202, management facility 102 may provide view 302-3 for display on mobile device 202.

As illustrated in FIG. 3, view 302-3 may include advertisement 304 as well as graphical object 316 identified as “Redeem Now” and graphical object 318 identified as “Cancel.” If management facility 102 detects a user input selecting graphical object 318, mobile device 202 may be directed to display a standard home screen of mobile device 202. However, if management facility 102 detects a user input selecting graphical object 316, management facility 102 may provide further information and/or a benefit (e.g., a coupon code, discount, etc.) associated with advertisement 304 to the user. In certain examples, view 302-3 may help prevent inadvertent engagement with advertisement 304 by a user, such as by giving the user an opportunity after mobile device 202 is unlocked to confirm that the user wants to engage with advertisement 304 or indicate that the user wants to dismiss advertisement 304 without further engagement.

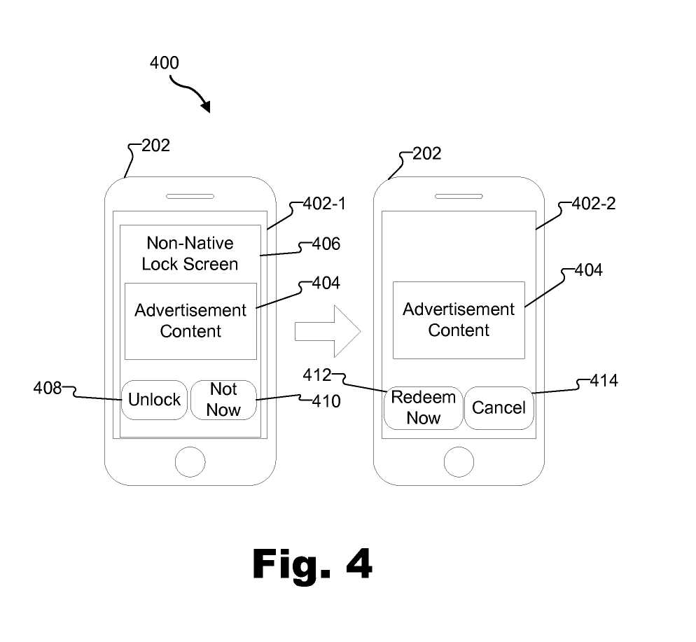

In certain examples, management facility 102 may bypass a native lock screen of the mobile device such that the user only interacts with a non-native lock screen to access an advertisement. To illustrate, FIG. 4 shows a progression 400 of exemplary graphical user interface views (e.g., views 402-1 through 402-2) that management facility 102 may provide for display on mobile device 202 when management facility 102 bypasses a native lock screen of mobile device 202. As shown in FIG. 4, view 402-1 includes an advertisement 404 that is provided by management facility 102 for display together with a non-native lock screen 406 that includes user-selectable graphical objects 408 and 410. Graphical objects 408 and 410 may be configured to operate in a similar manner to graphical objects 308 and 310 illustrated in FIG. 3.

If management facility 102 detects a user input associated with graphical object 408, management facility 102 may unlock mobile device 202 without the user having to interact with a native lock screen. After unlocking mobile device 202, management facility 102 may provide view 402-2 for display on mobile device 202. As shown in FIG. 4, view 402-2 may include advertisement 404 and graphical objects 412 and 414, which may operate in a manner similar to graphical objects 316 and 318 illustrated in FIG. 3.

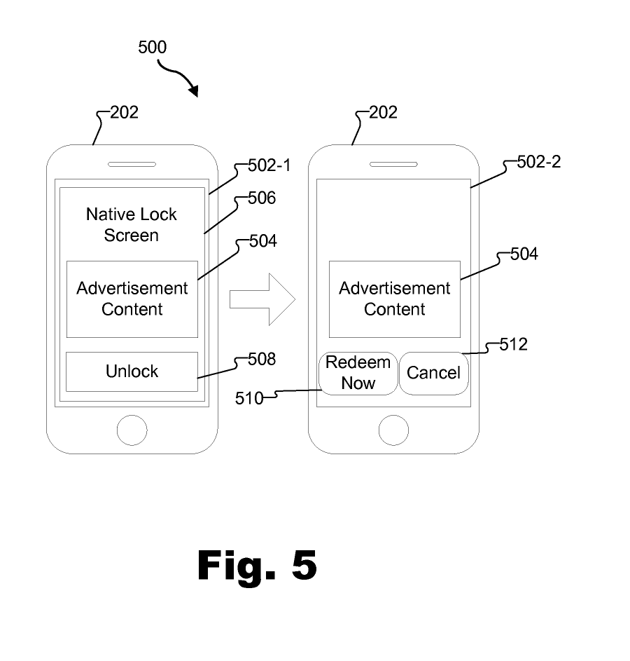

In certain examples, management facility 102 may provide an advertisement for display together with a native lock screen without the advertisement first being provided for display together with a non-native lock screen. To illustrate, FIG. 5 shows a progression 500 of exemplary graphical user interface views (e.g., views 502-1 through 502-2) that may be provided by management facility 102 for display on mobile device 202 when a native lock screen provides direct access to an advertisement. As shown in FIG. 5, view 502-1 may include an advertisement 504 that is provided for display by management facility 102 together with native lock screen 506 that includes a graphical object 508. Graphical object 508 may operate in a manner similar to graphical object 314 illustrated in FIG. 3.

If management facility 102 detects the user input associated with native lock screen 506 that unlocks mobile device 202, management facility 102 may provide view 502-2 for display on mobile device 202. As shown in FIG. 5, view 502-2 may include advertisement 504 as well as graphical objects 510 and 512, which may operate in a manner similar to graphical objects 316 and 318 illustrated in FIG. 3.

Management facility 102 may detect a sequence of user inputs associated with one or more graphical user interface views associated with the display of an advertisement together with a lock screen of a mobile device, including a sequence of user inputs associated with any of the graphical user interface views illustrated in FIGS. 3-5. A detected sequence of user inputs may span a single graphical user interface view, multiple graphical user interface views, and/or a specific progression of graphical user interface views. Additionally or alternatively, a detected sequence of user inputs may extend beyond a progression of graphical user interface views so as to include one or more user inputs associated with one or more other graphical user interface views that may precede and/or follow the progression of graphical user interface views.

In reference to the example illustrated in FIG. 3, for instance, a detected sequence of user inputs may include user input selecting graphical object 308 in view 302-1 followed by user input associated with graphical object 314 in view 302-2 to unlock mobile device 202 followed by user input selecting graphical object 316 in view 302-3. This particular sequence of user inputs may be associated, by definition, with one or more predefined user input sequence requirements and one or more billable impressions, as described above.

To illustrate, management facility 102 may determine that a first user input sequence requirement is satisfied when a user enters a user input selecting graphical object 308. As a result of such a user input, management facility 102 may identify a first billable impression. Management facility 102 may determine that a second user input sequence requirement is satisfied when the user enters a sequence of user inputs that includes a user input selecting graphical object 308 and one or more user inputs associated with graphical object 314. As a result of an occurrence of the sequence of user inputs associated with the second user input sequence requirement, management facility 102 may identify a second billable impression in addition to identifying the first billable impression. Management facility 102 may determine that a third user input sequence requirement is satisfied when the user enters a sequence of user inputs that includes a user input selecting graphical object 308, one or more user inputs associated with graphical object 314, and a user input selecting graphical object 316. As a result of an occurrence of the sequence of user inputs associated with the third user input sequence requirement, management facility 102 may identify a third billable impression in addition to identifying the first and the second billable impressions. Accordingly, a user input sequence associated the progression of user interface views illustrated in FIG. 3 may result in management facility 102 determining that the first, the second, and the third user input sequence requirements are satisfied and may result in management facility 102 identifying the first, the second, and the third billable impressions.

Alternatively, the sequence of user inputs may satisfy a single user input sequence requirement for a single billable impression. For example, the sequence of user inputs that includes a user input selecting graphical object 308, one or more user inputs associated with graphical object 314, and a user input selecting graphical object 316 may be defined (e.g., in advertisement data 106) as satisfying a single user input sequence requirement that results in management facility 102 identifying a single billable impression instead of the first, the second, and the third billable impressions.

Similarly, in reference to the example illustrated in FIG. 4, for instance, a detected sequence of user inputs may include user input selecting graphical object 408 in view 402-1 to unlock mobile device 202 followed by user input selecting graphical object 412 in view 402-2 to receive further information and/or a benefit associated with advertisement 404. This particular sequence of user inputs may be associated, by definition, with one or more predefined user input sequence requirements and one or more billable impressions, as described above.

To illustrate, management facility 102 may determine that a first user input sequence requirement is satisfied when a user enters a user input selecting graphical object 408. As a result of such a user input, management facility 102 may identify a first billable impression. Management facility 102 may determine that a second user input sequence requirement is satisfied when the user enters a sequence of user inputs that includes a user input selecting graphical object 408 and a user input selecting graphical object 412. As a result of an occurrence of the sequence of user inputs associated with the second user input sequence requirement, management facility 102 may identify a second billable impression in addition to identifying the first billable impression.

Similarly, in reference to the example illustrated in FIG. 5, for instance, a detected sequence of user inputs may include one or more user inputs associated with graphical object 508 in view 502-1 to unlock mobile device 202 followed by user input selecting graphical object 510 in view 502-2 to receive further information and/or a benefit associated with advertisement 504. This particular sequence of user inputs may be associated, by definition, with one or more predefined user input sequence requirements and one or more billable impressions, as described above.

To illustrate, management facility 102 may determine that a first user input sequence requirement is satisfied when a user enters one or more user inputs associated with graphical object 508. As a result of such a user input, management facility 102 may identify a first billable impression. Management facility 102 may determine that a second user input sequence requirement is satisfied when the user enters a sequence of user inputs that includes one or more user inputs associated with graphical object 508 and a user input selecting graphical object 510. As a result of an occurrence of the sequence of user inputs associated with the second user input sequence requirement, management facility 102 may identify a second billable impression in addition to identifying the first billable impression.

As mentioned, in certain examples, the detected sequences of user inputs described above may also include a sequence of user inputs that extends after a progression of graphical user interface views such as those illustrated in FIGS. 3-5. To illustrate, in the example shown in FIG. 4, after entering a user input selecting graphical object 412, the user may be presented with an additional graphical user interface view (e.g., a website) through which the user may purchase goods and/or services associated with advertisement 404. Accordingly, in such an example, the detected sequence of user inputs may also include a user input associated with the user making a purchase by way of the additional graphical user interface view.

As mentioned, in certain examples, the detected sequences of user inputs described above may also include a sequence of user inputs that extends before a progression of graphical user interface views such as those illustrated in FIGS. 3-5. To illustrate, in the example shown in FIG. 5, before the user enters a user input selecting graphical object 508, a display screen associated with mobile device 202 may be in a hibernated state (e.g., the display screen is turned off). For mobile device 202 to display view 502-1, the user may provide any suitable user input (e.g., a user input associated with a home button, a power button, etc.) to cause mobile device 202 to exit the hibernated state and display view 502-1. Accordingly, in such an example, the detected sequence of user inputs may also include a user input through which the user may activate the display screen associated with mobile device 202 to begin the particular progression of graphical user interface views illustrated in FIG. 5.

The exemplary user input sequences, user input sequence requirements, and billable impressions described above are provided for illustrative purposes only. Other user input sequences, user input sequence requirements, and/or billable impressions may be defined in other implementations.

In certain examples, management facility 102 may be configured to provide for display, together with the advertisement and the lock screen, a notification indicating that the advertisement is accessible to a user by unlocking the mobile device. Management facility 102 may provide the notification in any suitable manner. For example, the notification may correspond to a text-based notification, an image-based notification, and/or any other suitable notification that may be provided for display by management facility 102 together with a lock screen.

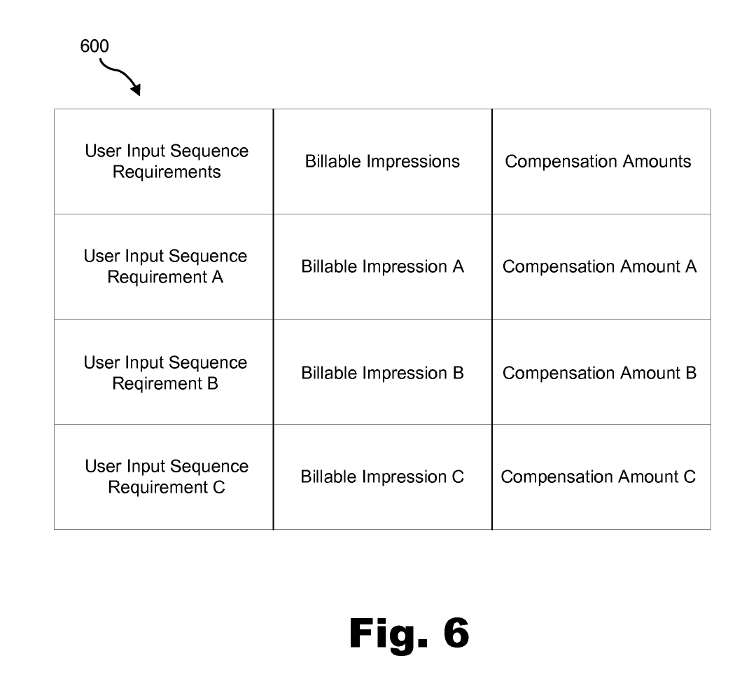

As discussed, in certain examples, management facility 102 may maintain a data structure that maps one or more predefined user input sequence requirements to one or more billable impressions. Management facility 102 may maintain such a data structure in any suitable manner. To illustrate, FIG. 6 shows an exemplary data structure in the form of a table 600 in which user input sequence requirements (e.g., user input sequence requirements A through C) are mapped, respectively, to billable impressions (e.g., billable impressions A through C). That is, user input sequence requirement A is mapped to billable impression A, etc. Management facility 102 may identify the one or more billable impressions based on the data that maps the predefined user input sequence requirement to the one or more billable impressions. For example, an advertiser (e.g., by way of advertiser system 206-1) may specify, when defining an advertisement campaign, that user input that unlocks of a mobile device when an advertisement is displayed together with a lock screen corresponds to user input sequence requirement A. The advertiser may specify that user inputs associated with a user confirming engagement with an advertisement after unlocking the mobile device correspond to user input sequence requirement B. The advertiser may also specify that user inputs associated with a user making a purchase as a result of accessing the advertisement corresponds to user input sequence requirement C. Accordingly, management facility 102 may monitor interactions of the user with the mobile device and detect when user input sequence requirements A through C are satisfied. Each time any one of user input sequence requirements A through C are satisfied, management facility 102 may determine that the corresponding billable impression A, B, and/or C has occurred. The above examples of user input sequence requirements and billable impressions are provided for illustrative purposes only. Any number of different user input sequence requirements and/or billable impressions may be specified by an advertiser and/or a provider of the service and represented in a data structure such as table 600 as may suit particular implementations.

In certain examples, management facility 102 may also maintain a data structure that maps each of the one or more billable impressions to a compensation amount to be billed to an advertiser. Management facility 102 may maintain such a data structure in any suitable manner. To illustrate, the table 600 shown in FIG. 6 also maps billable impressions A through C to corresponding compensation amounts (e.g., compensation amounts A through C). That is, billable impression A is mapped to compensation amount A, etc. By referring, for example, to the table illustrated in FIG. 6, management facility 102 may determine which compensation amounts are associated with the identified one or more billable impressions. The compensation amounts may be the same for each billable impression A through C or may vary depending on the particular implementation. For example, an advertiser may be willing to pay more for billable impression C than for billable impression A. To illustrate, billable impression A may be associated with the user accessing a website associated with the advertiser after viewing the advertisement together with a lock screen. However, billable impression C may be associated with the user making a purchase by way of the website. Accordingly, compensation amount C may be higher than compensation amount A because the user input resulted in a purchase.

After management facility 102 provides an advertisement for display together with a lock screen of a mobile device, management facility 102 may perform one or more operations that may benefit a provider of the service and/or an advertiser. Such operations may include invoicing operations, data collection operations, optimization operations, etc. To perform the one or more operations, management facility 102 may receive and/or retrieve any suitable information from the mobile device. Such information may include any information associated with an interaction and/or lack of interaction of a user with an advertisement and/or a lock screen. Examples of such operations will now be provided.

In certain examples, management facility 102 may provide statistical data, to a provider of the service and/or an advertiser, regarding a user's interaction with the service. The provider of the service and/or an advertiser may use such statistical data to modify and/or optimize advertisement campaigns. Accordingly, in certain examples, management facility 102 may be configured to maintain statistical data (e.g., as detection data 108) associated with the user preferences and choices as well as any other information associated with an interaction of the user with an advertisement and/or a lock screen. Management facility 102 may maintain and provide such statistical data to an advertiser in any suitable manner. For example, the statistical data may be provided to an advertiser in real time, on a periodic basis, and/or in any other suitable manner. Additionally or alternatively, such statistical data may be provided by management facility 102 to an advertiser as part of an agreement associated with an advertisement campaign and/or as part of a separately paid-for service that may facilitate the advertiser conducting market research and/or optimizing advertisement campaigns.

As discussed, in certain examples, the operations performed by management facility 102 may include invoicing an advertiser for billable impressions (e.g., by charging the advertiser specific compensation amounts mapped to identified billable impressions). To this end, management facility 102 may also track and maintain information associated with billable impressions for the purpose of providing invoices to advertisers as a result of their participation with the service. Management facility 102 may track the billable impressions and provide invoices to advertisers in any suitable manner. For example, management facility 102 may provide invoices in real time to advertisers as the billable impressions are detected. To illustrate, management facility 102 may generate and provide a separate invoice for each billable impression as each billable impression is detected. Alternatively, management facility 102 may generate and provide an invoice to an advertiser after a batch of billable impressions are detected during a predefined time period. To illustrate, management facility 102 may maintain records of all of the billable impressions detected in a month for a particular advertisement campaign. Management facility 102 may then generate a single invoice for the entire month that bills an advertiser for the sum of all of the compensation amounts associated with the billable impressions detected during the month. Management facility 102 may be configured to charge an advertiser for identified billable impressions in any other manner as may suit a particular implementation.

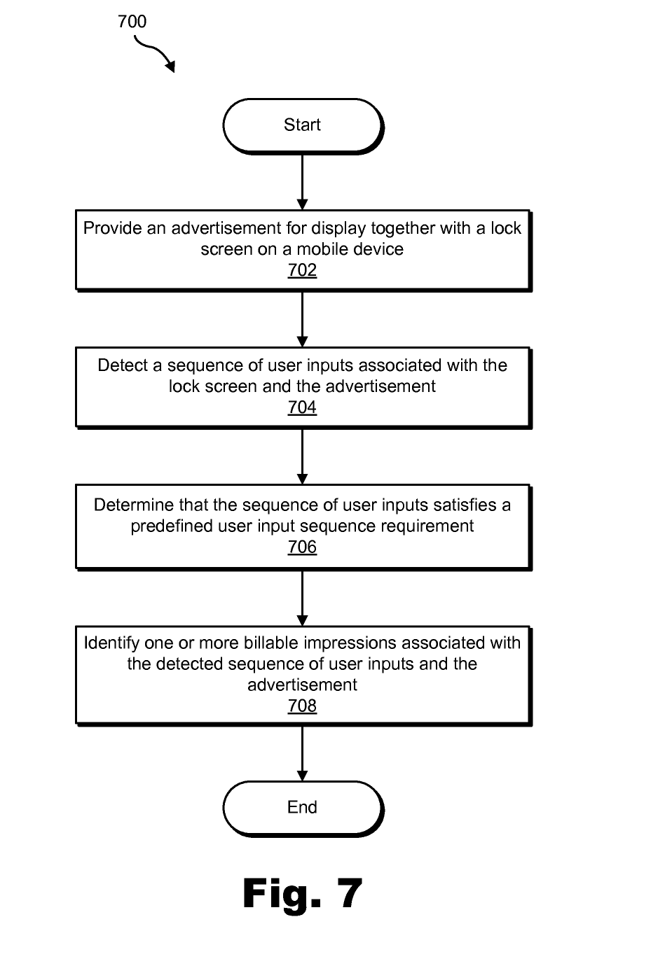

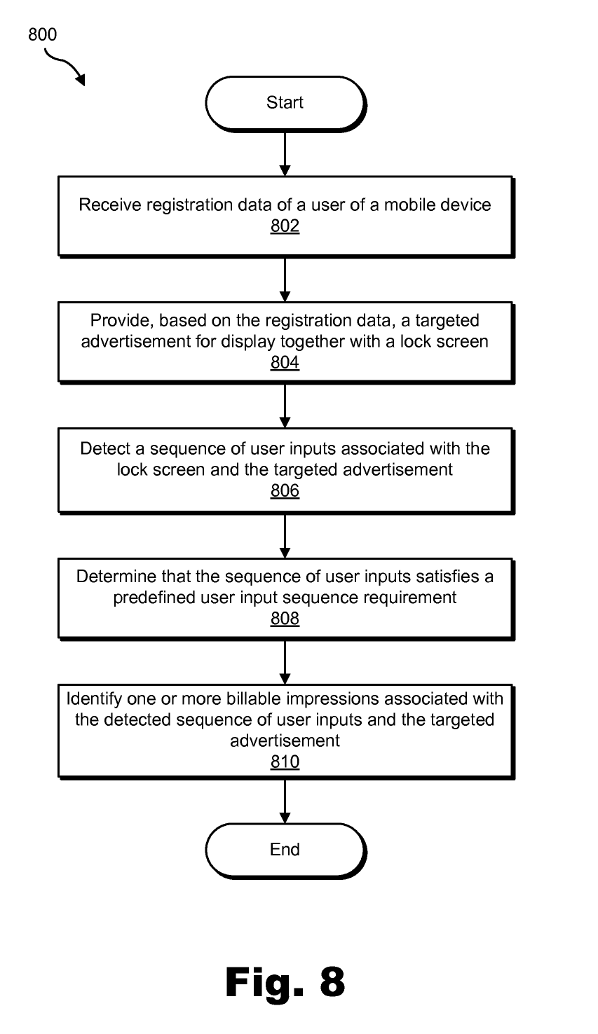

FIGS. 7-8 illustrate exemplary lock-screen-based advertisement delivery methods 700-800 that may be performed according to principles described herein. While FIGS. 7-8 illustrate exemplary steps according to certain embodiments, other embodiments may omit, add to, reorder, combine, and/or modify any of the steps shown in FIGS. 7-8. In certain embodiments, one or more of the steps shown in FIGS. 7-8 may be performed by system 100 and/or one or more components or implementations of system 100.

Turning to method 700 illustrated in FIG. 7, in step 702, a system (e.g., system 100) provides an advertisement for display together with a lock screen on a mobile device. Step 702 may be performed in any of the ways described herein.

In step 704, the system detects a sequence of user inputs associated with the lock screen and the advertisement. Step 704 may be performed in any of the ways described herein.

In step 706, the system determines that the sequence of user inputs satisfies a predefined user input sequence requirement. Step 706 may be performed in any of the ways described herein.

In step 708, the system identifies one or more billable impressions associated with the detected sequence of user inputs and the advertisement. As described above, the identification may be based on the determination that the sequence of user inputs satisfies the predefined user input sequence requirement in step 706. Step 708 may be performed in any of the ways described herein.

Turning to method 800 illustrated in FIG. 8, in step 802, a system (e.g., system 100) receives registration data of a user of a mobile device. As described above, the registration data may include information indicating that the user has agreed to receive a targeted advertisement to be displayed together with a lock screen on the mobile device (e.g., by opting in to a service). Step 802 may be performed in any of the ways described herein.

In step 804, the system provides, based on the registration data, a targeted advertisement for display together with the lock screen. Step 804 may be performed in any of the ways described herein.

In step 806, the system detects a sequence of user inputs associated with the lock screen and the targeted advertisement. Step 806 may be performed in any of the ways described herein.

In step 808, the system determines that the sequence of user inputs satisfies a predefined user input sequence requirement. Step 808 may be performed in any of the ways described herein.

In step 810, the system identifies one or more billable impressions associated with the detected sequence of user inputs and the targeted advertisement. As described above, the identification may be based on the determination that the sequence of user inputs satisfies the predefined user input sequence requirement in step 808. Step 810 may be performed in any of the ways described herein.

In certain embodiments, one or more of the components and/or processes described herein may be implemented and/or performed by one or more appropriately configured computing devices. To this end, one or more of the systems and/or components described above may include or be implemented as one or more computing systems and/or components by any computer hardware, computer-implemented instructions (e.g., software) embodied in a non-transitory computer-readable medium, or combinations of computer-implemented instructions and hardware, configured to execute one or more of the processes described herein. In particular, system components may be implemented on one physical computing device or may be implemented on more than one physical computing device. Accordingly, system components may include any number of physical computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media and/or volatile media. Non-volatile media may include, for example, optical or magnetic disks and other persistent memory. Volatile media may include, for example, dynamic random access memory (DRAM), which typically constitutes a main memory. Common forms of computer-readable media include, for example, a floppy disk, flexible disk, hard disk, magnetic tape, any other magnetic medium, a Compact Disc Read-Only Memory (CD-ROM), DVD, any other optical medium, a Random-Access Memory (RAM), a Programmable ROM (PROM), an Erasable PROM (EPROM), a Flash Electrically EPROM (FLASH-EEPROM), any other memory chip or cartridge, or any other tangible medium from which a computer may read.

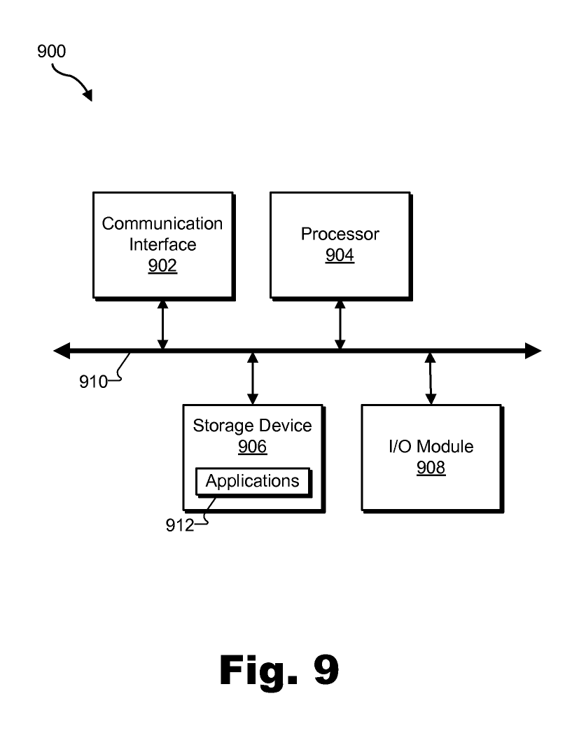

FIG. 9 illustrates an exemplary computing device 900 that may be configured to perform one or more of the processes described herein. As shown in FIG. 9, computing device 900 may include a communication interface 902, a processor 904, a storage device 906, and an input/output (I/O) module 908 communicatively connected via a communication infrastructure 910. While an exemplary computing device 900 is shown in FIG. 9, the components illustrated in FIG. 9 are not intended to be limiting. Additional or alternative components may be used in other embodiments. Components of computing device 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a modem, and any other suitable interface. In at least one embodiment, communication interface 902 may provide a direct connection between system 100 and one or more of provisioning systems via a direct link to a network, such as the Internet. Communication interface 902 may additionally or alternatively provide such a connection through, for example, a local area network (such as an Ethernet network), a personal area network, a telephone or cable network, a satellite data connection, a dedicated URL, or any other suitable connection. Communication interface 902 may be configured to interface with any suitable communication media, protocols, and formats, including any of those mentioned above.

Processor 904 generally represents any type or form of processing unit capable of processing data or interpreting, executing, and/or directing execution of one or more of the instructions, processes, and/or operations described herein. Processor 904 may direct execution of operations in accordance with one or more applications 912 or other computer-executable instructions such as may be stored in storage device 906 or another computer-readable medium.

Storage device 906 may include one or more data storage media, devices, or configurations and may employ any type, form, and combination of data storage media and/or device. For example, storage device 906 may include, but is not limited to, a hard drive, network drive, flash drive, magnetic disc, optical disc, random access memory (RAM), dynamic RAM (DRAM), other non-volatile and/or volatile data storage units, or a combination or sub-combination thereof. Electronic data, including data described herein, may be temporarily and/or permanently stored in storage device 906. For example, data representative of one or more executable applications 912 (which may include, but are not limited to, one or more of the software applications described herein) configured to direct processor 904 to perform any of the operations described herein may be stored within storage device 906. In some examples, data may be arranged in one or more databases residing within storage device 906.

I/O module 908 may be configured to receive user input and provide user output and may include any hardware, firmware, software, or combination thereof supportive of input and output capabilities. For example, I/O module 908 may include hardware and/or software for capturing user input, including, but not limited to, a keyboard or keypad, a touch screen component (e.g., touch screen display), a receiver (e.g., an RF or infrared receiver), and/or one or more input buttons.

I/O module 908 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation.

In some examples, any of the systems and/or facilities described herein may be implemented by or within one or more components of computing device 900. For example, one or more applications 912 residing within storage device 906 may be configured to direct processor 904 to perform one or more processes or functions associated with system 100 or any components thereof.

To the extent the aforementioned embodiments collect, store, and/or employ personal information provided by individuals (or other entities), it should be understood that such information shall be used in accordance with all applicable laws concerning protection of personal information. Additionally, the collection, storage, and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

In the preceding description, various exemplary implementations have been described with reference to the accompanying drawings. It will, however, be evident that various modifications and changes may be made thereto, and additional implementations may be provided, without departing from the scope of the invention as set forth in the claims that follow. For example, certain features of one implementation described herein may be combined with or substituted for features of another implementation described herein. The description and drawings are accordingly to be regarded in an illustrative rather than a restrictive sense.

What is claimed is:

1. A method comprising:
providing, by an advertisement delivery system, an advertisement for display together with a lock screen on a mobile device;
detecting, by the advertisement delivery system, a sequence of user inputs associated with the lock screen and the advertisement;
determining, by the advertisement delivery system, that the sequence of user inputs satisfies a predefined user input sequence requirement; and
identifying, by the advertisement delivery system based on the determining that the sequence of user inputs satisfies the predefined user input sequence requirement, one or more billable impressions associated with the detected sequence of user inputs and the advertisement.

2. The method of claim 1, further comprising:
maintaining, by the advertisement delivery system, data that maps each of the one or more billable impressions to a compensation amount to be billed to a provider of the advertisement; and
determining, by the advertisement delivery system based on the identified one or more billable impressions and the data, one or more compensation amounts associated with the identified one or more billable impressions.

3. The method of claim 1, further comprising:
maintaining, by the advertisement delivery system, data that maps the predefined user input sequence requirement to the one or more billable impressions;
wherein the identifying of the one or more billable impressions is based on the data that maps the predefined user input sequence requirement to the one or more billable impressions.

4. The method of claim 1, wherein the identifying of the one or more billable impressions comprises identifying one or more of
a first billable impression associated with a user unlocking the mobile device while the advertisement is displayed together with the lock screen,
a second billable impression associated with the user interacting with the advertisement after unlocking the mobile device, and
a third billable impression associated with the user making a purchase by way of the advertisement after unlocking the mobile device.

5. The method of claim 1, further comprising providing, by the advertisement delivery system for display together with the advertisement and the lock screen, a notification that the advertisement is accessible to a user by unlocking the mobile device.

6. The method of claim 1, wherein the lock screen comprises a non-native lock screen that is not a standard lock screen of the mobile device.

7. The method of claim 6, wherein the sequence of user inputs comprises:
a first user input associated with the non-native lock screen that facilitates access to a native lock screen of the mobile device;
a second user input associated with the native lock screen that unlocks the mobile device to facilitate access to the advertisement; and
a third user input associated with an interaction of a user with the advertisement while the mobile device is unlocked.

8. The method of claim 7, wherein the third user input comprises an input to confirm engagement with the advertisement.

9. The method of claim 7, further comprising providing, by the advertisement delivery system for display together with the advertisement and the non-native lock screen, one or more graphical objects that facilitate the first user input.

10. The method of claim 6, further comprising:
bypassing, by the advertisement delivery system, a native lock screen of the mobile device;
wherein the sequence of user inputs comprises:
a first user input associated with the non-native lock screen that unlocks the mobile device to facilitate access to the advertisement; and
a second user input associated with an interaction of a user with the advertisement while the mobile device is unlocked.

11. The method of claim 1, further comprising providing, by the advertisement delivery system for display together with the advertisement and the lock screen, one or more graphical objects, wherein the one or more graphical objects comprise
a first graphical object that, when selected, facilitates access to the advertisement, and
a second graphical object that, when selected, dismisses the advertisement.

12. The method of claim 1, wherein the lock screen comprises a native lock screen of the mobile device.

13. The method of claim 12, wherein the sequence of user inputs comprises:
a first user input associated with the native lock screen that unlocks the mobile device to facilitate access to the advertisement; and
a second user input associated with an interaction of a user with the advertisement while the mobile device is unlocked.

14. The method of claim 1, wherein the advertisement fills substantially an entire display screen of the mobile device when provided for display together with the lock screen.

15. The method of claim 1, embodied as computer-executable instructions on at least one non-transitory computer-readable medium.

16. A method comprising:
receiving, by an advertisement delivery system, registration data of a user of a mobile device, the registration data including information indicating that the user has agreed to receive a targeted advertisement to be displayed together with a lock screen on the mobile device;
providing, by the advertisement delivery system based on the registration data, the targeted advertisement for display together with the lock screen;
detecting, by the advertisement delivery system, a sequence of user inputs associated with the lock screen and the targeted advertisement;
determining, by the advertisement delivery system, that the sequence of user inputs satisfies a predefined user input sequence requirement; and
identifying, by the advertisement delivery system based on the determining that the sequence of user inputs satisfies the predefined user input sequence requirement, one or more billable impressions associated with the detected sequence of user inputs and the targeted advertisement.

17. The method of claim 16, wherein the registration data includes timing information identifying a predefined time period in which the user agreed to receive the targeted advertisement.

18. The method of claim 16, wherein:
the registration data includes location information identifying a geographic location at which the user agreed to receive the targeted advertisement; and
the providing of the targeted advertisement includes detecting that the mobile device is located at the geographic location and selecting the targeted advertisement based on the geographic location.

19. The method of claim 16, embodied as computer-executable instructions on at least one non-transitory computer-readable medium.

20. A system comprising:
at least one physical computing device that
provides an advertisement for display together with a lock screen on a mobile device;
detects a sequence of user inputs associated with the lock screen and the advertisement;
determines that the sequence of user inputs satisfies a predefined user input sequence requirement; and
identifies, based on the determining that the sequence of user inputs satisfies the predefined user input sequence requirement, one or more billable impressions associated with the detected sequence of user inputs and the advertisement.
